(19) United States
(12) Patent Application Publication
(10) Pub. No.: US 2026/0270225 A1
(43) Pub. Date: Sep. 10, 2026

(54) Clustered Message Labeling

(71) Applicant: Proofpoint, Inc., Sunnyvale, CA (US)

(72) Inventors: Gabriel Infante-Lopez, Cordoba (AR); Cameron Michael Schmauch, Los Gatos, CA (US); Cameron Kyle Malloy, Fremont, CA (US); Matthew Joseph Schlesinger, Moraga, CA (US); Facundo Nahuel Maldonado Medina, Cordoba (AR)

(21) Appl. No.: 19/074,156

(22) Filed: Mar. 7, 2025

(51) Int. Cl. H04L 51/04; H04L 9/32

(52) U.S. Cl. CPC H04L 51/04; H04L 9/3236

(57) ABSTRACT

A message designated for a recipient is received. Message scanning is performed on one or more portions of the message to obtain a hash value for each portion of the one or more portions. The message is classified to one or more clusters based on each hash value. It is determined if the message is malicious based on whether other messages classified to a same cluster as the message have been labeled as malicious.

### FIELD

This disclosure relates generally to malicious message detection and, more specifically, to labeling an entire cluster of received messages when one of the received messages of the cluster has been determined to be malicious.

### BACKGROUND

Users of mobile computing devices face various cybersecurity threats, from malicious phishing attempts to spam messages. While some tools have been developed to combat these threats, it remains difficult to prevent malicious messages from being delivered to recipients. This is particularly true when the number of messages sent each day continues to dramatically increase and the cybersecurity landscape continues to change at a fast rate.

### SUMMARY

A method is described. A message designated for a recipient is received. Message scanning is performed on one or more portions of the message to obtain a hash value for each portion of the one or more portions. The message is classified to one or more clusters based on each hash value. It is determined if the message is malicious based on whether other messages classified to a same cluster as the message have been labeled as malicious.

The one or more clusters that the message has been classified to may be updated when it is determined that the message is malicious. Updating the one or more clusters may include labeling each message classified to the one or more clusters as malicious. A machine learning model may be updated using labeled cluster training data corresponding to each message labeled as malicious. The updated machine learning model may be used to determine whether received messages are malicious.

The message may include one of an email, a text message, or a chat message. The message scanning may use a semantic scanner on each portion of the one or more portions. Messages classified to a first cluster may each include semantically similar portions. The message scanning may use a syntactic scanner on each portion of the one or more portions. Messages classified to a first cluster each include syntactically similar portions.

The message scanning may be performed on every message prior to the message being provided to the recipient. Each cluster may have a dynamic range that is adjustable as new messages are classified to each cluster. A first message may be reclassified from a first cluster to a second cluster when the range of the first cluster changes such that a first hash value for a first portion of the first message is no longer within the range of the first cluster and is now within a range of the second cluster. Additional clusters may be automatically defined for hash values outside the ranges of currently defined clusters.

The message scanning may use Locality-Sensitive Hashing (LSH) on each portion of text of the message. Each portion of text of the message may include three words, a sentence, or a paragraph in the message.

A computing platform is also described. The computing platform includes a memory and a processor. The processor is configured to execute instructions stored in the memory to receive a message designated for a recipient. The processor is also configured to execute instructions stored in the memory to perform message scanning on one or more portions of the message to obtain a hash value for each portion of the one or more portions. The processor is further configured to execute instructions stored in the memory to classify the message to one or more clusters based on each hash value. The processor is also configured to determine if the message is malicious based on whether other messages classified to a same cluster as the message have been labeled as malicious.

A non-transitory computer readable medium storing instructions operable to cause one or more processors to perform operations is described. The instructions are operable to cause the one or more processors to receive a message designated for a recipient. The instructions are also operable to cause the one or more processors to perform message scanning on one or more portions of the message to obtain a hash value for each portion of the one or more portions. The instructions are further operable to cause the one or more processors to classify the message to one or more clusters based on each hash value. The instructions are also operable to cause the processor to determine if the message is malicious based on whether other messages classified to a same cluster as the message have been labeled as malicious.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an operating environment for executing real-time message monitoring to identify potentially malicious messages.

FIG. 2 is a block diagram of an example of a system for performing clustered machine learning.

FIG. 3 is an example of a technique for scanning received messages and classifying them to message clusters.

FIG. 4 is an example of a technique for labeling a cluster corresponding to received messages.

FIG. 5 is a block diagram illustrating a syntactic hashing function.

FIG. 6 is a block diagram illustrating a semantic hashing function.

### DETAILED DESCRIPTION

Supervised machine learning algorithms typically require training material to build models before the supervised machine learning algorithms can be used. This process can often take days, weeks, or even months to complete. Until the models are built, the supervised machine learning algorithms aren't particularly helpful at completing their desired task.

For inference, such as the detection of malicious messages, supervised machine learning algorithms could provide significant improvements, except that a typical malicious message campaign may only last for a few hours. By the time the training materials have been identified, properly labeled, and used to build the models, the malicious message campaign is likely to be over. This problem is exacerbated by the rapid pace at which the threat landscape evolves. For example, a threat actor of a malicious message campaign may generate seed messages, with each seed message being vastly different from the other seed messages. When a seed message gets through a malicious detection algorithm (i.e., when the seed message is known to be delivered), the threat actor may immediately start a malicious message campaign where the seed message is altered in many different minor ways and sent to hundreds of thousands or even millions of different recipients. The threat actor expects these minor alterations to fool automated malicious message detection tools, thereby resulting in a significant number of the malicious messages being delivered to recipients.

A hash function is often used to map portions of received messages to hash values, where messages that are similar are mapped to the same hash value. The granularity of the hash function's domain is usually extensive, meaning that malicious messages can be scattered across different hash values. Thus, the typical approach of using a supervised method that relies on labeling certain hash values as legitimate or malicious will be insufficient, as new attacks and malicious signatures are constantly emerging.

What is needed is supervised machine learning algorithms that can react faster to the rapidly evolving security landscape. By classifying portions of each message, and then grouping similar classified portions into clusters, large groups/clusters of messages can be simultaneously labeled as malicious when only one message in the cluster is deemed to be malicious. The clustering and labeling of messages is the machine learning cycle; once the labeling has been performed, the machine learning model can begin correctly identifying incoming messages as malicious.

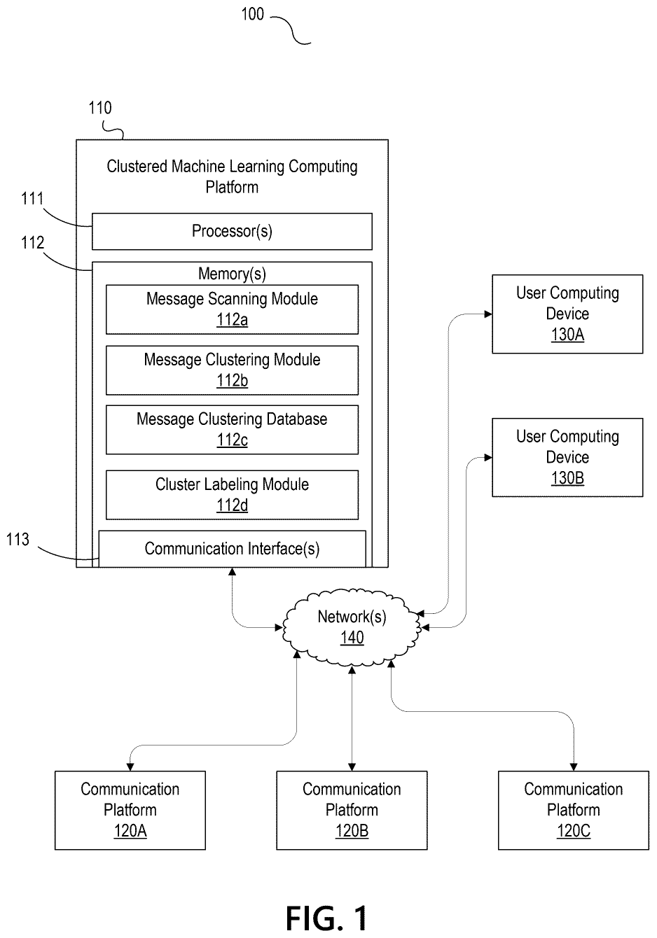

FIG. 1 depicts an illustrative operating environment for performing clustered machine learning in accordance with one or more example embodiments. Referring to FIG. 1, a computing environment 100 may include various computer systems, computing devices, networks, and/or other operating infrastructure. For example, the computing environment 100 may include a clustered machine learning computing platform 110, communication platforms 120, user computing devices 130, and one or more network(s) 140.

Network(s) 140 may include one or more wired networks and/or one or more wireless networks that interconnect the clustered machine learning computing platform 110, communication platforms 120, user computing devices 130, and/or other computer systems and/or devices. In addition, each of the clustered machine learning computing platform 110, communication platforms 120, and user computing devices 130 may be special purpose computing devices configured to perform specific functions, as illustrated in greater detail below, and may include specific computing components such as processors, memories, communication interfaces, and/or the like.

The clustered machine learning computing platform 110 may include one or more processor(s) 111, one or more memory(s) 112, and one or more communication interface(s) 113. In some instances, the clustered machine learning computing platform 110 may be made up of a plurality of different computing devices (e.g., arranged as a computing platform), which may be distributed within a single data center or a plurality of different data centers. In these instances, the one or more processor(s) 111, one or more memory(s) 112, and one or more communication interface(s) 113 included in the clustered machine learning computing platform 110 may be part of and/or otherwise associated with the different computing devices that form the clustered machine learning computing platform 110.

In one or more arrangements, processor(s) 111 may control operations of the clustered machine learning computing platform 110. Memory(s) 112 may store instructions that, when executed by the processor(s) 111, cause the clustered machine learning computing platform 110 to perform one or more functions, as discussed below. The communication interface(s) 113 may include one or more wired and/or wireless network interfaces, and the communication interface(s) 113 may connect the clustered machine learning computing platform 110 to one or more networks (e.g., network 140) and/or enable the clustered machine learning computing platform 110 to exchange information and/or otherwise communicate with one or more devices connected to such networks.

In one or more arrangements, memory(s) 112 may store and/or otherwise provide a plurality of modules (which may include instructions that may be executed by processor(s) 111 to cause the clustered machine learning computing platform 110 to perform various functions) and/or databases (which may store data used by the clustered machine learning computing platform 110 in performing various functions). For example, the memory(s) 112 may store and/or otherwise provide a message scanning module 112a, a message clustering module 112b, one or more message clustering databases 112c, and a cluster labeling module 112d.

In some instances, the message scanning module 112a may store instructions that cause the clustered machine learning computing platform 110 to implement bulk mail detection and enforcement, and/or one or more other functions described herein. The message scanning module 112 may scan messages and output classification information for each scanned message. The message clustering module 112b may store instructions that cause the clustered machine learning computing platform 110 to group the classification information into clusters that are stored in the one or more message clustering databases 112c. The one or more message clustering databases 112c may store information that the clustered machine learning computing platform 110 may use to implement malicious message detection and enforcement, and/or one or more other functions described herein. Furthermore, the cluster labeling module 112d may store instructions that may be used by the clustered machine learning computing platform 110 to label an entire cluster of messages as malicious when one message classified to that cluster has been determined to be malicious.

The communication platforms 120 may be configured to send messages using a communications service. The communication platforms 120 may be a server device used to send bulk or spam messages to users. The communication platforms 120 may also be a communications platform as a service (CPaaS) that provides bulk messaging sending capabilities. Alternatively, the communication platforms 120 may be a consumer device or any other device that may be used to send messages to users.

The user computing devices 130 may be configured to be used by respective users to receive messages from the communication platforms 120, and may also be able to send messages. The user computing devices 130 could be user-owned devices, employer-provided devices, or other types of devices used by respective users. The user computing devices 130 may be configured to present one or more user interfaces associated with messaging functions as described below.

In one or more arrangements, a communication service involves many different devices, and any given device may be able to receive and send various types of messages, including text messages, emails, and chats, from and to any number of other devices. As used herein, the communication platforms 120 and the user computing devices 130 may represent respective senders and recipients of bulk or spam messages in order to illustrate one or more aspects of the disclosure. Thus, although the examples below describe the communication platforms 120 sending exemplary messages to the user computing devices 130, which may be flagged as malicious messages, some implementations of the disclosure may include many senders and receivers of messages, which may be capable of sending various messages to each other.

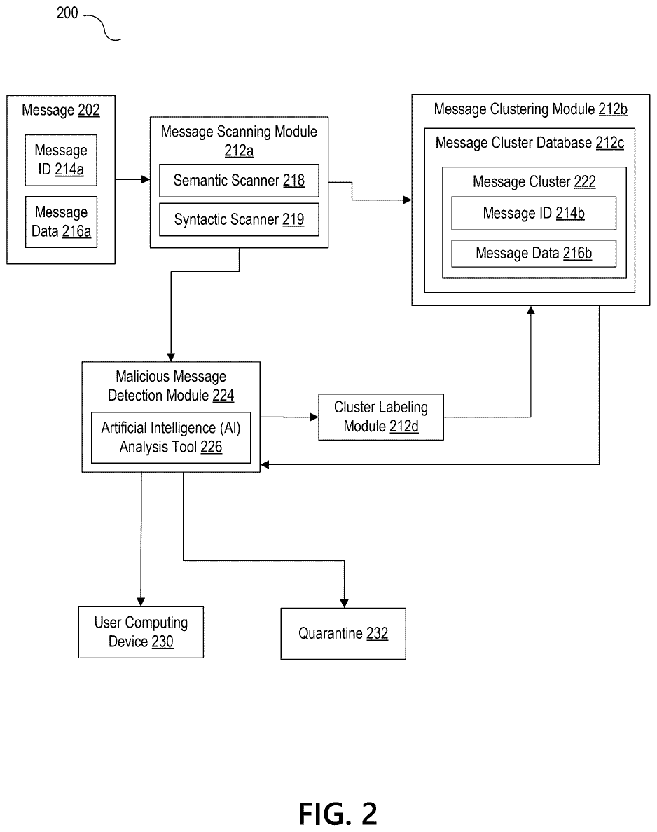

FIG. 2 is a block diagram of an example of a system 200 for performing clustered machine learning. The system 200 includes a message scanning module 212a that scans all received messages 202 before those messages 202 are delivered to their intended recipients. Each received message 202 may include message data 216a, such as the sender of the message 202, the intended recipient(s) of the message 202, the message text, attachment information, and the sender's Internet Protocol (IP) address. Not every received message 202 includes all of this message data 216a, and many malicious messages 202 are specifically designed to obfuscate some parts of the malicious message 202.

Each message 202 can be defined by a message ID 214a. The message ID 214a uniquely identifies each message 202. One way to uniquely identify a message 202 is to perform a hash function on the message 202, with the resulting hash value uniquely identifying the message 202 as the message ID 214a.

The message scanning module 212a may perform message scanning on every received message 202. For message scanning, the text of a message 202 is broken into smaller portions or chunks. For example, a portion may be every three words, every sentence, or every paragraph within the message 202. Different sizes of the portions may affect the speed and granularity of the message scanning module 212a, and may thus determine the accuracy of the message scanning module 212a. In one configuration, the size of the portions of text may be dynamically altered. For example, if too many messages 202 are classified to a particular cluster 222, the size of the portions of text of future messages 202 scanned by the message scanning module 212a may be increased to spread out the classification of messages 202 across the clusters 222. Likewise, if too few messages 202 are classified to certain clusters 222, the size of the portions of text of future messages 202 may be decreased to better group the messages 202 to clusters 222.

One way threat actors attempt to bypass malicious message detection is through the use of semantic tools. A semantic tool may take a portion of text from a first message (such as a seed message) and change the words in a second message while maintaining the semantic meaning. For example, a semantic tool may replace “I haven't seen you for a long time” with “It's been awhile since we last chatted.” Using a semantic tool can turn one seed message into thousands or even millions of unique messages 202, each with nearly the same meaning.

Another way threat actors attempt to bypass malicious message detection is through the use of syntax tools. A syntax tool may take a portion of text from a first message (such as a seed message) and change the words in a second message while maintaining the syntax (e.g., while remaining syntactically similar to the words in the original message). For example, a syntax tool may replace “I haven't seen you for a long time” with “We haven't heard from you for a few months.” Using a syntax tool can also turn one seed message into thousands or even millions of unique messages 202, each with nearly the same syntax.

Message scanning may include using a semantic scanner 218 that classifies portions of text using semantic rules. Message scanning may also include using a syntactic 219 scanner that classifies portions of text using syntactic rules. The semantic scanner 218 and the syntactic scanner 219 may each be used individually or in combination. In one embodiment, the semantic scanner 218 and the syntactic 219 scanner may each use Locality-Sensitive Hashing (LSH) on a received message 202. LSH defines a hashing function that is applied to different types of objects (in this case portions of text in the received message 202), with the key feature being that two similar objects will receive the same hash value if they are sufficiently similar. Similar hash values can be grouped together to form a cluster 222, where the range/boundaries of the cluster 222 define how similar the portions of each message 202 are. By defining the domain of the hash function more narrowly, the portions of many different received messages 202 that are similar (e.g., semantically or syntactically) can be identified.

Using the message data 216b (i.e., the computed hash values for portions of text in a message 202), each received message 202 can be classified into one or more clusters 222 by a message clustering module 212b. The message clustering module 212b may store the message data 216b and the message ID 214b of a message 202 classified to a message cluster 222 in a message cluster database 212c. Each received message 202 may thus be classified to one or more clusters 222, depending on the number of defined clusters 222 and the length and complexity of each message 202. The number of clusters 222 may depend on the variability of the computed hash values of received messages 202 and the granularity selected for each cluster 222 (i.e., how close the computed hash values are to each other to be defined as being part of the same cluster 222). Each cluster 222 may thus have a defined range of hash values, and any message 202 with a portion of text that has a hash value within the range of a cluster 222 will be classified to that cluster 222. Since the clusters 222 won't be used for anything other than hash value matching, each cluster 222 doesn't require a naming structure.

In one configuration, the number and granularity of the clusters 222 can dynamically change. For example, additional clusters 222 can be defined as messages 202 are received. When new clusters 222 are defined, the boundaries or ranges of other clusters 222 may be adjusted and messages 202 classified to clusters 222 may be reclassified to the new clusters 222, depending on the hash value boundaries of the new cluster 222. Additional clusters 222 can be added and defined automatically by the message clustering module 212b or manually by an analyst.

Each received message 202 may also be processed by a malicious message detection module 224. The malicious message detection module 224 may use many different automated methods to determine whether a received message 202 is potentially malicious. In particular, the malicious message detection module 224 may use an artificial intelligence (AI) analysis tool 226 to evaluate whether each received message 202 is malicious. The artificial intelligence (AI) analysis tool 226 may use labeled training data to detect threat signatures in received messages 202 and thereby identify those received messages 202 as malicious. For example, the artificial intelligence (AI) analysis tool 226 may use the message data 216b produced by the message scanning module 212a performing scanning on a message 202 to determine which message clusters 222 the message 202 is classified to. The malicious message detection module 224 may then compare the clusters 222 that the message 202 is classified to with message clusters 222 stored in the message cluster database 212c to determine whether those clusters 222 have been labeled as malicious. If one or more of the clusters 222 that the message 202 is classified to have been labeled as malicious in the message cluster database 212c, then the message 202 may also be determined to be malicious.

Received messages 202 that are determined to be malicious may be deleted or placed in quarantine 232, depending on the settings for specific customers. Those received messages 202 that are placed in quarantine 232 can be reviewed by the recipient and designated as not malicious (e.g., if the recipient evaluates the received message 202 and deems it to not be malicious). Received messages 202 that are not determined to be malicious (either because the received messages 202 are not malicious or because the received messages 202 are part of a threat campaign that has not yet been identified) may be delivered to the user computing device 230 of the recipient.

As threat landscapes constantly evolve, threat messages 202 may bypass existing malicious message detection tools. Threat analysts may review these received messages 202 and may discover markers/signatures indicating that a received message 202 is malicious (either before or after the message 202 is delivered to the recipient). When an analyst marks a message 202 as malicious, a cluster labeling module 212d may apply labeling data to the clusters 222 that the message 202 has been classified into. For example, if an analyst determines that Message A is malicious, and Message A has been classified to Cluster 1, Cluster 2, and Cluster 3, then every message 202 classified to Cluster 1, Cluster 2, or Cluster 3 may automatically be labeled as malicious. In this sense, the tagging of a received message 202 as malicious happens in real time and the hashing function learns the tagging immediately. When a cluster 222 has been labeled as malicious, the malicious message detection module 224 will tag all future received messages 202 that have been classified to the same cluster 222 as malicious, thereby responding to changes in the landscape more quickly than the traditional machine learning process of labeling, training, and inference.

A threat analyst may discover markers/signatures indicating that a received message 202 is malicious in many different ways, including the recipient marking the received message 202 as potentially malicious, opening the received message 202 and any attachments in a sandbox environment and discovering malicious code, or selecting messages 202 having specific criteria for additional analysis. For example, a threat analyst could monitor the number of messages 202 classified to each cluster 222 and randomly select one of those messages 202 for additional analysis if the number of messages 202 classified to the cluster 222 goes above a threshold. As another example, a threat analyst could randomly review a received message 202 if more than a threshold number of received messages 202 have all been classified to the same three clusters 222 as the received message 202. The threat analyst may then determine whether a particular analyzed message 202 is malicious.

If a received message 202 is classified to more than one cluster 222 and the received message 202 has been deemed malicious, every cluster 222 that the received message 202 has been classified to may not be associated with malicious messages. For example, non-malicious messages 202 may include some of the same language as malicious messages 202 and may thus be classified to some of the same clusters 222 as malicious messages 202. Thus, the cluster labeling module 212d may only label a particular cluster 222 as malicious if there are strong indications that every message 202 classified to the cluster 222 is malicious. The cluster labeling module 212d may use heuristics to determine which clusters 222 are labeled as malicious when a threat analyst tags a received message 202 as malicious. In one configuration, the cluster labeling module 212d may only label a cluster 222 as malicious if more than a threshold number of received messages 202 classified to that cluster 222 were also classified to another cluster 222 that the determined malicious message 202 was also classified to. For example, if a received message 202 deemed malicious by a threat analyst has been classified to Cluster 1, Cluster 2, and Cluster 3, where 60% of the messages 202 classified to Cluster 1 were also classified to Cluster 2 but only 10% of the messages 202 classified to Cluster 1 were also classified to Cluster 3, only Cluster 1 and Cluster 2 may be automatically labeled as malicious (and thereby only messages 202 classified to Cluster 1 and/or to Cluster 2 will be automatically labeled as malicious). The threat analyst may also be triggered to look closer at messages 202 classified to Cluster 3 to look for additional markers/signatures suggesting maliciousness.

After a threat campaign has concluded, the labeled cluster data (i.e., the message data 216b corresponding to a cluster 222 that has been deemed as malicious) may be used as training data for the artificial intelligence (AI) analysis tool 226. The size and number of clusters 222 may also be periodically reduced/restarted to avoid overly biasing the message clustering module 212b for future threat detection.

Received messages 202 that were tagged as malicious by the malicious message detection module 224, placed in quarantine 232, and later opened by an end user and tagged as being not malicious may trigger feedback to the threat analyst and to the message clustering module 212b. For example, if more than a threshold number of received messages 202 are classified to a cluster 222 that was labeled as malicious but then later verified by end users to not be malicious, the message clustering module 212b may remove the malicious label for that particular cluster 222 or prompt a threat analyst to review the clusters 222 that were labeled as malicious to determine if the labeling was incorrect. The determination that a cluster 222 labeled as malicious is incorrect may inform the message clustering module 212b and the threat analyst of iterative changes to the classification model. For example, feedback from messages 202 later determined to be non-malicious may be used to train the message clustering module 212b to change the size/scope of each cluster 222, define additional clusters 222 to be used in the future, remove clusters 222 from being used in the future, and train the semantic scanner 218 and/or the syntactic scanner 219 to use smaller or bigger portions of text of received messages 202. The feedback may also be used to adjust relative weights applied to the semantic scanner 218 and the syntactic scanner 219, if both are used together, or to apply weights to other received message scanners.

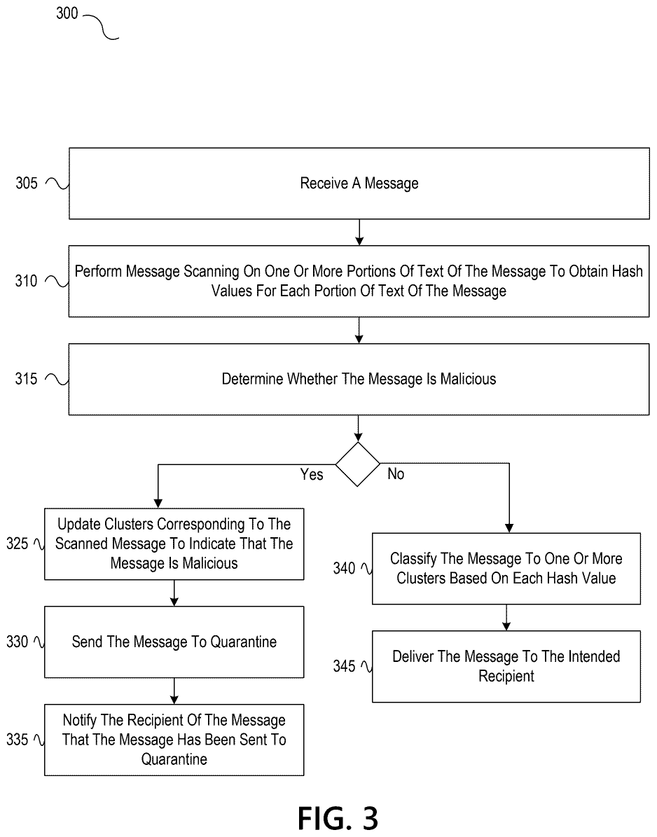

FIG. 3 is an example of a technique 300 for scanning received messages 202 and classifying them to message clusters 222. The technique 300 can be executed using computing devices, such as the systems, hardware, and software described with respect to FIGS. 1-2. The technique 300 can be performed, for example, by executing a machine-readable program or other computer-executable instructions, such as routines, instructions, programs, or other code. The steps, or operations, of the technique 300 or another technique, method, process, or algorithm described in connection with the implementations disclosed herein can be implemented directly in hardware, firmware, software executed by hardware, circuitry, or a combination thereof. The technique 300 can be performed by a software platform.

At 305, a message 202 is received. The message 202 may be an email, a chat message, a text message (such as message sent over the short message service (SMS) or the multimedia messaging service (MMS)), an instant message, or other type of message 202. The received messages 202 may include bulk text, spam text, and phishing text, including automated messages 202 informing users of status updates, product updates, offers, promotions, and may include unwanted or undesirable automated messages 202 sent without the recipient's consent. The messages 202 may be received by the clustered machine learning computing platform 110 from multiple communications platforms 120 (e.g., communications platform 120a and communications platform 120b).

The messages 202 may be in transit to one or more user computing devices 130 (e.g., user computing device 130a and user computing device 130b). For example, the communications platform 120a may send out one or more messages 202 to various users for spam or phishing purposes. In some cases, a single entity may use multiple communications platforms to send out messages 202. Thus, for example, a single sender may use the communications platform 120a and the communications platform 120b to send out messages 202 to users associated with each user computing device 130. The different communication platforms 120 may not indicate that they are from the same sender (e.g., one may use one sender email address, and another may use a different sender email address), especially in the case of spam and phishing messages. Additionally, each communications platform 120 may use multiple sender identifiers (e.g., multiple email addresses). For example, if the communications platform 120a sends multiple email messages to the user computing device 130a, some of the email messages may originate from a first email address and some may originate from a second email address.

At 310, message scanning is performed on one or more portions of text of the message 202 to obtain hash values for each portion of text of the message 202. The message scanning may include semantic scanning, syntactic scanning, or other forms of scanning (such as image matching or attachment matching). In one configuration, the message scanning may use a hash function to map similar hash values of similar messages. The message scanning may be performed once for each received message 202 or multiple times to ensure that the message 202 is properly classified. For example, different portions of text (and/or different sizes of the portions of text) of the message 202 may be scanned to ensure that the message 202 is properly classified to the correct clusters 222. In one configuration, a message 202 may be rescanned if the message 202 is not classified to at least 3 different clusters 222.

At 315, it is determined whether the received message 202 is malicious. A message 202 may be determined to be malicious based on the message attributes (such as a classification of the message 202 to a cluster 222 that has been deemed malicious by a threat analyst) or based on other attributes (such as the received message 202 being sent from a known threat actor). Artificial intelligence (AI) may be employed to determine whether a message 202 is malicious.

At 325, if the message 202 has been determined to be malicious, the clusters 222 corresponding to the message 202 (i.e., the clusters 222 that the message 202 has been classified to) may be updated to account for the maliciousness determination. For example, if one or more of the clusters 222 corresponding to the received malicious message 202 have not previously been associated with a malicious message 202, those clusters 222 may be updated to be associated with the malicious message 202 and additional labeling of the messages 202 classified to the clusters 222 as malicious may be performed. As another example, the strength of the determination that a particular cluster 222 is associated with malicious messages 202 may be adjusted/increased (either towards a threshold that, when achieved, causes the cluster 222 to be tagged as malicious or further strengthens a previous determination that a cluster 222 is malicious) when a message 202 is found to be malicious that has been classified to that particular cluster 222.

At 330, the message is sent to quarantine 232. The quarantine 232 may hold the message 202 for a period of time to allow a recipient to review the message 202 and determine whether they believe the message 202 is malicious. In one configuration, feedback from recipients of a message 202 deemed to be malicious may be used to update the determination that the message 202 is malicious and thus may also be used as feedback for the labeling of other messages 202 classified to a same cluster 222 as the message 202. If a recipient indicates that a message 202 classified as malicious is not malicious, it may trigger a threat analyst to review the message 202 and/or other messages 202 (past or future) classified to one or more of the same clusters 222 as the malicious message 202 for additional analysis. Messages 202 that have been placed in quarantine 232 based on being classified to a same cluster 222 as a message 202 that was found to be malicious using other means (such as in-depth analysis by a threat analyst) may be automatically removed from quarantine 232 if the same cluster 222 is deemed to no longer be definitive about the maliciousness of messages 202 classified to that cluster 222.

At 335, the recipient of the message 202 is notified that the message 202 was sent to quarantine 232. The recipient of the message 202 may be able to view the sender of the message 202 and/or the contents of the message 202 and remove the message 202 from quarantine 232 at their discretion. For example, the recipient of the message may be able to click a button on a user interface (UI) that removes the message 202 from quarantine 232. When a recipient indicates that a quarantined message 232 was incorrectly quarantined (i.e., that the recipient does not believe the message 202 to be malicious), the clusters 222 may again be updated to account for this new information. For example, the clusters 222 associated with the message 202 that have been tagged as malicious may be untagged as malicious and labels associated with those clusters 222 may be removed. In one configuration, the selection by a recipient to remove a message 202 from quarantine 232 may have no effect on the message 202 classifications or the clusters 222.

At 340, if the message 202 has not been determined to be malicious (and thus has been determined to be benign for the time being), the message 202 may be classified to one or more clusters 222 based on each hash value computed for each portion of text of the message 202. In particular, each cluster 222 that the message 202 has been classified to may be updated to include reference to the message 202 and the message attributes (e.g., the hash value of the portion of text of the message 202 that corresponds to the range of the cluster 222).

At 345, the message 202 may then be delivered to the intended recipient. For example, the received message 202 may be forwarded or moved to the email inbox of the intended recipient.

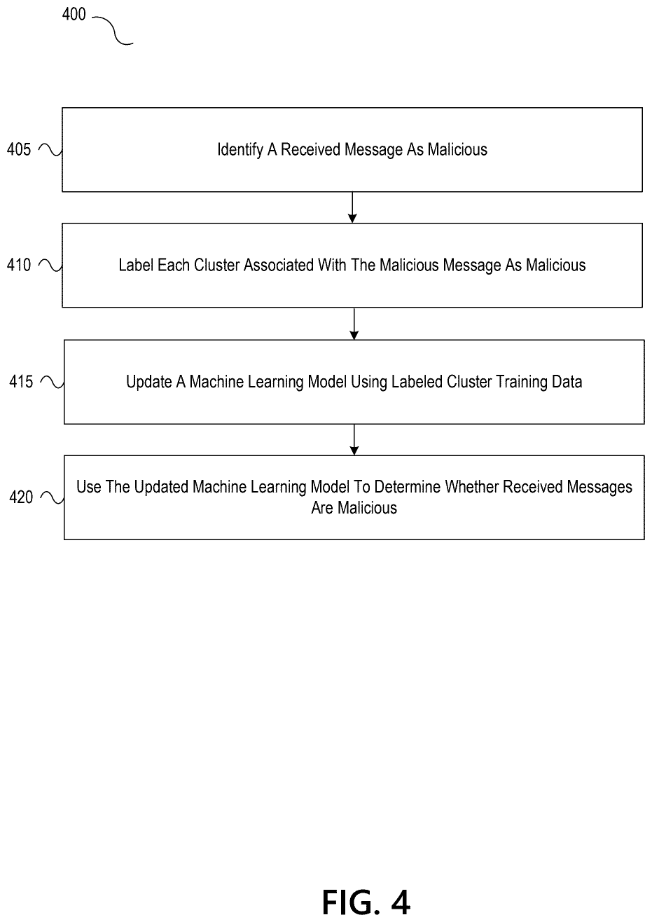

FIG. 4 is an example of a technique 400 for labeling a cluster corresponding to received messages. The technique 400 can be executed using computing devices, such as the systems, hardware, and software described with respect to FIGS. 1-2. The technique 400 can be performed, for example, by executing a machine-readable program or other computer-executable instructions, such as routines, instructions, programs, or other code. The steps, or operations, of the technique 400 or another technique, method, process, or algorithm described in connection with the implementations disclosed herein can be implemented directly in hardware, firmware, software executed by hardware, circuitry, or a combination thereof. The technique 400 can be performed by a software platform.

At 405, a received message 202 is identified as malicious. A received message 202 may be identified as malicious by a threat analyst. For example, a threat analyst may regularly review messages 202 that were not flagged as malicious by the malicious message detection module 224. In one configuration, some received messages 202 that were not flagged as malicious by the malicious message detection module 224 may be processed by additional tools to look for additional threat markers. These additional tools may be much slower than the malicious message detection module 224, which has to analyze messages fast to avoid delays. In another configuration, a message 202 may be identified as malicious based on feedback from a recipient of the message 202. For example, a recipient may click a button that identifies a message 202 as fraudulent, phishing, spam, or malicious. A threat analyst may then review the message 202 and determine whether the message 202 is actually malicious.

At 410, once a message 202 has been identified as malicious, labeling may be applied to each cluster 222 associated with the message 202 to obtain labeled training data. In one configuration, the clusters 222 associated with the message 202 identified as malicious may already be known (e.g., the message data 216b and message ID 214b of the message 202 may be stored in a message cluster database 212c as part of one or more message clusters 222). In another configuration, the message 202 identified as malicious may be rescanned (or scanned for a first time) by the message scanning module 212a to determine which clusters 222 are associated with the message 202. Some or all of the clusters 222 associated with the message 202 identified as malicious may then be labeled as malicious. For each cluster 222 that is labeled as malicious, every message 202 classified to the cluster 222 is also labeled as malicious. This creates a large amount of labeled training data without having to wait for each message 202 to be individually labeled by a threat analyst as malicious. Instead, a large number of messages 202 can be labeled as malicious at the same time. For example, 10, 100, or even 1,000 messages 202 could all be labeled as malicious at the same time.

At 415, a machine learning model is updated using the labeled training data of the clusters 222. For example, the artificial intelligence (AI) analysis tool 226 may be updated to use message clusters 222 that have been labeled as malicious to review and identify newly received messages 202 for maliciousness. The clustered machine learning computing platform 110 may update its training data set based on the labeled training data and re-train one or more machine learning models (e.g., the machine learning model used at step 405). In some cases, outputs of the machine learning models may be verified (e.g., by a human or another source of information about senders) before using the output and the associated inputs to update a training data set. Thus, by using real world data to improve its training data and models, the clustered machine learning computing platform 110 may be able to adapt to changing tactics and techniques used in attempts to circumvent policy enforcement.

At 420, the updated machine learning model is used to determine whether received messages 202 are malicious. Received messages 202 that are classified using the message scanning to correspond to one of the clusters 222 that has been labeled as malicious are automatically tagged as malicious and placed in quarantine 232.

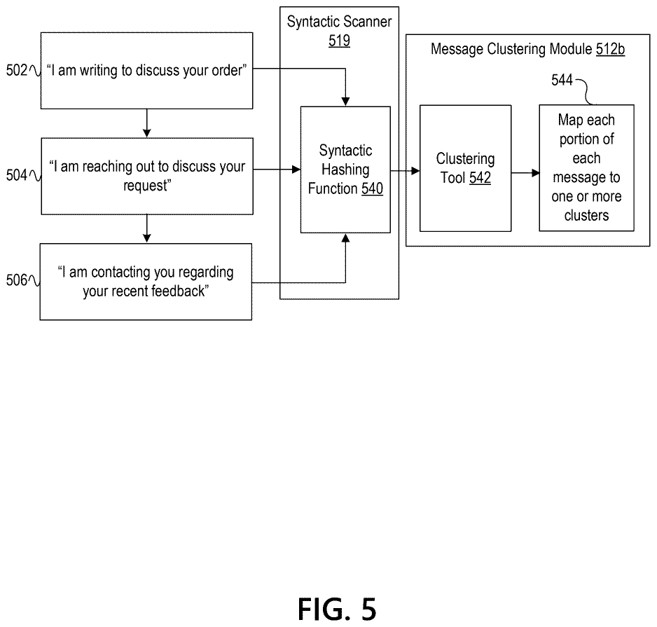

FIG. 5 is a block diagram illustrating a syntactic hashing function 540. Three different (but syntactically similar) portions of text of messages 202 are shown. The first portion 502 of a first message 202 states “I am writing to discuss your order.” The second portion 504 of a second message 202 states “I am reaching out to discuss your request.” The third portion 506 of a third message 202 states “I am contacting you regarding your recent feedback.” Each of the portions of the messages 202 have similar (but not identical) character sequences and are thus likely to have similar hash values from a syntactic hashing function 540. Each of the portions is fed to a syntactical hashing function 540 as part of a syntactic scanner 519 that computes a hash value for each portion of each message 202. Each computed hash value can then be mapped 544 to one or more cluster 222s (either an existing cluster 222 or a new cluster 222 if the hash value is outside the boundaries of the currently defined clusters 222) by a clustering tool 542 that is part of a message clustering module 512b. Depending on the boundaries of the clusters 222, computed hash values of the portions of the messages 202 may be mapped 544 to (and associated with) the same cluster 222 or to different clusters 222.

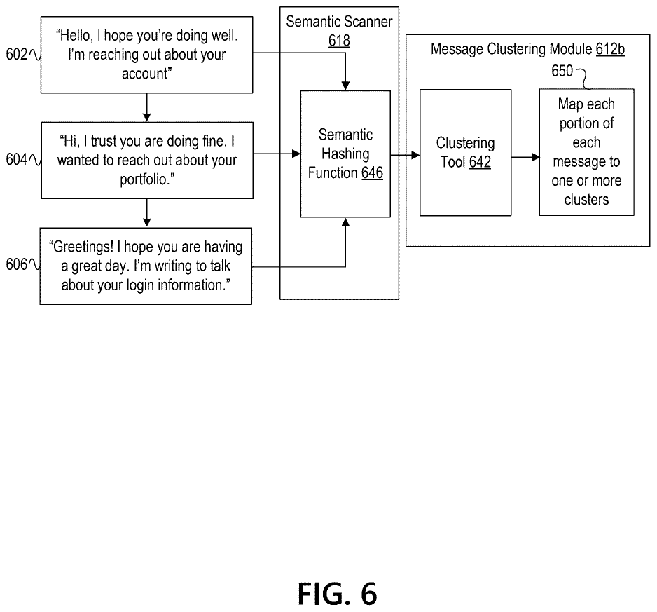

FIG. 6 is a block diagram illustrating a semantic hashing function 646. Three different (but semantically similar) portions of messages 202 are shown. The first portion 602 of a first message 202 states “Hello, I hope you're doing well. I'm reaching out about your account.” The second portion 604 of a second message 202 states “Hi, I trust you are doing fine. I wanted to reach out about your portfolio.” The third portion 606 of a third message 202 states “Greetings! I hope you are having a great day. I'm writing to talk about your login information.” Each of the portions of the messages 202 have similar (but not identical) meanings and are thus likely to have similar hash values from a semantic hashing function 646. Each of the portions is fed to a semantic hashing function 646 as part of a semantic scanner 618 that computes a hash value for each portion. Each computed hash value can then be mapped 650 to one or more clusters 222 (either an existing cluster 222 or a new cluster 222 if the hash value is outside the boundaries of the currently defined clusters 222) by a clustering tool 642 as part of a message clustering module 612b. Depending on the boundaries of the clusters 222, computed hash values of the portions of the messages 202 may be mapped to the same cluster 222 or to different clusters 222.

For simplicity of explanation, the techniques 300 and 400 of FIGS. 3 and 4 are depicted and described herein as respective series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving a message designated for a recipient;
performing message scanning on one or more portions of the message to obtain a hash value for each portion of the one or more portions;
classifying the message to one or more clusters based on each hash value; and
determining if the message is malicious based on whether other messages classified to a same cluster as the message have been labeled as malicious.

2. The method of claim 1, further comprising updating the one or more clusters that the message has been classified to when it is determined that the message is malicious.

3. The method of claim 2, wherein updating the one or more clusters comprises labeling each message classified to the one or more clusters as malicious.

4. The method of claim 3, further comprising:
updating a machine learning model using labeled cluster training data corresponding to each message labeled as malicious; and
using the updated machine learning model to determine whether received messages are malicious.

5. The method of claim 1, wherein the message comprises one of an email, a text message, or a chat message.

6. The method of claim 1, wherein the message scanning uses a semantic scanner on each portion of the one or more portions, and wherein messages classified to a first cluster each comprise semantically similar portions.

7. The method of claim 1, wherein the message scanning uses a syntactic scanner on each portion of the one or more portions, and wherein messages classified to a first cluster each comprise syntactically similar portions.

8. The method of claim 1, wherein the message scanning is performed on every message prior to the message being provided to the recipient.

9. The method of claim 1, wherein each cluster has a dynamic range that is adjustable as new messages are classified to each cluster, and wherein a first message is reclassified from a first cluster to a second cluster when the range of the first cluster changes such that a first hash value for a first portion of the first message is no longer within the range of the first cluster and is now within a range of the second cluster.

10. The method of claim 1, wherein additional clusters are automatically defined for hash values outside the ranges of currently defined clusters.

11. The method of claim 1, wherein the message scanning uses Locality-Sensitive Hashing (LSH) on each portion of text of the message.

12. The method of claim 11, wherein each portion of text of the message comprises three words, a sentence, or a paragraph in the message.

13. A computing platform, comprising:
a memory; and
a processor, the processor configured to execute instructions stored in the memory to:
receive a message designated for a recipient;
perform message scanning on one or more portions of the message to obtain a hash value for each portion of the one or more portions;
classify the message to one or more clusters based on each hash value; and
determine if the message is malicious based on whether other messages classified to a same cluster as the message have been labeled as malicious.

14. The computing platform of claim 13, wherein the processor is further configured to execute instructions stored in the memory to:
update the one or more clusters that the message has been classified to when it is determined that the message is malicious.

15. The computing platform of claim 14, wherein updating the one or more clusters comprises labeling each message classified to the one or more clusters as malicious.

16. The computing platform of claim 14, wherein the processor is further configured to execute instructions stored in the memory to:
update a machine learning model using labeled cluster training data corresponding to each message labeled as malicious; and
use the updated machine learning model to determine whether received messages are malicious.

17. A non-transitory computer readable medium storing instructions operable to cause one or more processors to perform operations comprising:
receiving a message designated for a recipient;
performing message scanning on one or more portions of the message to obtain a hash value for each portion of the one or more portions;
classifying the message to one or more clusters based on each hash value; and
determining if the message is malicious based on whether other messages classified to a same cluster as the message have been labeled as malicious.

18. The non-transitory computer readable medium of claim 17, wherein the one or more processors are further configured to perform operations comprising:
updating the one or more clusters that the message has been classified to when it is determined that the message is malicious.

19. The non-transitory computer readable medium of claim 18, wherein updating the one or more clusters comprises labeling each message classified to the one or more clusters as malicious.

20. The non-transitory computer readable medium of claim 19, wherein the one or more processors are further configured to perform operations comprising:
updating a machine learning model using labeled cluster training data corresponding to each message labeled as malicious; and
using the updated machine learning model to determine whether received messages are malicious.
